(19) United States
(12) Patent Application Publication
(10) Pub. No.: US 2014/0322629 A1
(43) Pub. Date: Oct. 30, 2014

(54) NITRATE REDUCTION METHOD, NITRATE REDUCTION CATALYST, NITRATE REDUCTION ELECTRODE, FUEL CELL, AND WATER TREATMENT APPARATUS

(71) Applicants: Panasonic Corporation, Osaka (JP); JAPAN SCIENCE AND TECHNOLOGY AGENCY, Saitama (JP)

(72) Inventors: Shuji Nakanishi, Osaka (JP); Kazuhito Hashimoto, Tokyo (JP); Kazuhide Kamiya, Tokyo (JP)

(21) Appl. No.: 14/361,579

(22) PCT Filed: Dec. 7, 2012
(86) PCT No.: PCT/JP2012/081753

§ 371 Date: May 29, 2014

(30) Foreign Application Priority Data
Dec. 9, 2011 (JP) 2011-269761

(51) Int. Cl. C02F 1/461; H01M 4/96; H01M 8/22

(52) U.S. Cl. CPC C02F 1/46109; H01M 8/222; H01M 4/96; C02F 2001/46133
USPC 429/504; 205/760; 210/748.16; 204/242; 204/275.1; 423/445 R; 423/448

(57) ABSTRACT

A nitrate reduction method in accordance with the present invention reduces at least one type of nitrates and nitrites in a presence of a carbon-based material containing at least one selected from a group consisting of graphite, graphene, and amorphous carbon.

### TECHNICAL FIELD

The present invention relates to nitrate reduction methods, nitrate reduction catalysts used in the nitrate reduction methods, nitrate reduction electrodes including the nitrate reduction catalyst, water treatment apparatuses and fuel cells each including the catalyst.

### BACKGROUND ART

The nitrate reduction reaction in which nitrates and nitrites are reduced to produce nitrogen gas is expected to be applied to techniques of removing nitrogen from water.

In the past, although, as an electrode for causing such a nitrate reduction reaction, there have been mainly proposed electrodes containing noble metal catalyst such as platinum, sufficient studies have not yet been made on such electrodes.

In this regard, graphite is inexpensive and stably available and further has high electrical conductivity, though graphite is considered to be poor in reactivity. Therefore, in the past, carbon-based materials such as graphite have not been studied to use them as a catalyst for the nitrate reduction reaction.

Recently, non Patent Literature 1 reports use of a carbon-alloy catalyst for nitrate reduction. However, this report does not relate to a carbon-based material that alone has the catalytic activity.

### CITATION LIST

### Non Patent Literature

Non Patent Literature 1: Chem. Commun., 2011, 47, 3496

### SUMMARY OF INVENTION

### Technical Problem

The present invention has been made in view of the above circumstances, and the object thereof is to provide: a nitrate reduction method capable of efficiently promoting the nitrate reduction reaction without a noble metal catalyst such as platinum; a nitrate reduction catalyst showing high catalytic activity owing to including a carbon-based material that alone shows catalytic activity; a nitrate reduction electrode including the catalyst; and a fuel cell and a water treatment apparatus each including the catalyst.

### Solution to Problem

The nitrate reduction method in accordance with the first invention is a method of reducing at least one type of nitrates and nitrites in a presence of a carbon-based material containing at least one selected from a group consisting of graphite, graphene, and amorphous carbon.

The nitrate reduction catalyst in accordance with the second invention includes a carbon-based material which contains at least one selected from a group consisting of graphite, graphene, and amorphous carbon.

The nitrate reduction electrode in accordance with the third invention includes the nitrate reduction catalyst in accordance with the second invention.

The water treatment apparatus in accordance with the fourth invention includes: a vessel to receive an aqueous solution containing at least one type of nitrates and nitrites; and an anode and a cathode both in the vessel, and the cathode is the nitrate reduction electrode in accordance with the third invention.

The water treatment apparatus in accordance with the fifth invention includes: a vessel to receive an aqueous solution containing ammonium ions and at least one type of nitrates and nitrites; a base material which is electrically conductive and disposed in the vessel; an oxidation catalyst supported on the base material; and the nitrate reduction catalyst in accordance with the second invention, and the nitrate reduction catalyst is supported on the base material and not in contact with the oxidation catalyst.

The fuel cell in accordance with the sixth invention includes: a vessel to receive an aqueous solution containing ammonium ions and at least one type of nitrates and nitrites; and an anode and a cathode both in the vessel, and the cathode is the nitrate reduction electrode in accordance with the third invention.

### Advantageous Effects of Invention

According to the present invention, high catalytic activity is obtained owing to a carbon-based material that alone has catalytic activity, and therefore nitrates and nitrites can be reduced with high efficiency.

According to the present invention, it is possible to provide a nitrate reduction catalyst with high catalytic activity owing to including a carbon-based material that alone has catalytic activity, a nitrate reduction electrode including the catalyst, a water treatment apparatus and a fuel cell each including the catalyst.

### BRIEF DESCRIPTION OF DRAWINGS

FIG. 1 is a schematic view of an example of a water treatment apparatus in accordance with the present invention;

FIG. 2 is a schematic view of a water treatment apparatus which is almost the same as the water treatment apparatus shown in FIG. 1 but is different in further including a pH adjuster and a nitrite supplier;

FIG. 3 is a schematic view of another example of a water treatment apparatus in accordance with the present invention;

FIG. 4 is a schematic view of a water treatment apparatus which is almost the same as the water treatment apparatus shown in FIG. 3 but is different in further including a pH adjuster and a nitrite supplier;

FIG. 5 is a schematic view of an example of a fuel cell in accordance with the present invention;

FIG. 6 is a schematic view of a fuel cell which is almost the same as the water treatment apparatus shown in FIG. 5 but is different in further including a pH adjuster and a nitrite supplier;

FIG. 7 shows voltammograms regarding Example 1 and Comparative Example 1 obtained by performing cyclic voltammetry in an aqueous solution of HNO₃;

FIG. 8 shows voltammograms on electrodes in Examples 2-1, 2-2, and 2-3 obtained by performing cyclic voltammetry in an aqueous solution of 0.5 M HNO₃;

FIG. 9 shows voltammograms on an electrode obtained in Example 3-1 and a platinum electrode obtained by performing cyclic voltammetry in an aqueous solution of 5 M HNO₃ (pH: −0.7);

FIG. 10 shows voltammograms on an electrode in Example 3-2 obtained by performing cyclic voltammetry in an aqueous solution of 0.1 M HNO₃ (pH: 1) and in pure water;

FIG. 11 shows voltammograms on an electrode in Example 3-3 obtained by performing cyclic voltammetry in an aqueous solution of 0.1 M HNO₃ and 5 M H₂SO₄ (pH: −0.7) and in pure water;

FIG. 12 shows a graph showing a time course of a current at an electrode in Example 4-1 in an aqueous solution of 5 M HNO₃ when a constant current is applied;

FIG. 13 shows a graph showing time courses of currents at an electrode in Example 4-2 in an aqueous solution of 5 M H₂SO₄, 10 mM HNO₃, and 1 mM HNO₂ and in an aqueous solution of 5 M H₂SO₄ and 1 mM HNO₂ without HNO₃, when a constant current is applied; and

FIG. 14 shows a graph showing time courses of currents at an electrode in Example 5 and a platinum electrode in an aqueous solution of 5M HNO₃ when a constant current is applied and methanol is added therein at a predetermined time.

### DESCRIPTION OF EMBODIMENTS

According to the first aspect of the present invention, there is provided a nitrate reduction method of reducing at least one type of nitrates (nitrate ions) and nitrites (nitrite ions) in a presence of a carbon-based material containing at least one selected from a group consisting of graphite, graphene, and amorphous carbon.

The nitrate reduction method according to the second aspect of the present invention referring to the first aspect, includes steps of; preparing an aqueous solution containing at least one type of the nitrates and the nitrites; and applying a voltage across the aqueous solution by use of a cathode defined by a nitrate reduction electrode including the carbon-based material.

The nitrate reduction method according to the third aspect of the present invention referring to the first or second aspect, further includes a step of adjusting a pH of the aqueous solution to a range of −0.5 to −0.7.

According to the fourth aspect of the present invention referring to any one of the first to third aspects, the aqueous solution contains the nitrates, and the nitrate reduction method further includes a step of adding the nitrites to the aqueous solution.

The nitrate reduction catalyst according to the fifth aspect of the present invention, contains a carbon-based material containing at least one selected from a group consisting of graphite, graphene, and amorphous carbon.

The nitrate reduction electrode according to the sixth aspect of the present invention, includes the nitrate reduction catalyst according to the fifth aspect.

According to the seventh aspect of the present invention referring to the fifth or sixth aspect, an onset potential at the nitrate reduction electrode for nitrate reduction is 0.8 V (vs. Ag/AgCl).

The water treatment apparatus according to the eighth aspect of the present invention, includes: a vessel to receive an aqueous solution containing at least one type of nitrates and nitrites; and an anode and a cathode both in the vessel, the cathode being the nitrate reduction electrode according to the sixth or seventh aspect.

The water treatment apparatus according to the ninth aspect of the present invention, includes: a vessel to receive an aqueous solution containing ammonium ions and at least one type of nitrates and nitrites; a base material which is electrically conductive and disposed in the vessel; an oxidation catalyst supported on the base material; and the nitrate reduction catalyst according to the fifth aspect, the nitrate reduction catalyst being supported on the base material and not in contact with the oxidation catalyst.

The water treatment apparatus according to the tenth aspect of the present invention referring to the eighth or ninth aspect, further includes a pH adjuster for adjusting a pH of the aqueous solution to a range of −0.5 to −0.7.

The water treatment apparatus according to the eleventh aspect of the present invention referring to any one of the eighth to tenth aspect, further includes a nitrite supplier for supplying the nitrites to the aqueous solution.

The fuel cell according to the twelfth aspect of the present invention, includes: a vessel to receive an aqueous solution containing ammonium ions and at least one type of nitrates and nitrites; and an anode and a cathode both in the vessel, the cathode being the nitrate reduction electrode according to the sixth or seventh aspect.

The fuel cell according to the thirteenth aspect of the present invention referring to the twelfth aspect, further includes a pH adjuster for adjusting a pH of the aqueous solution to a range of −0.5 to −0.7.

The fuel cell according to the fourteenth aspect of the present invention referring to the twelfth or thirteenth aspect, further includes a nitrite supplier for supplying the nitrites to the aqueous solution.

According to the fifteenth aspect of the present invention, the carbon-based material is preferably doped with nitrogen atoms.

The nitrate reduction catalyst according to the sixteenth aspect of the present invention, includes the carbon-based material according to the fifteenth aspect.

The nitrate reduction electrode according to the seventeenth aspect of the present invention, includes the carbon-based material according to the fifteenth aspect.

According to the seventeenth aspect, an onset potential at the nitrate reduction electrode for nitrate reduction is preferably 1.0 V or more (vs. SHE).

The fuel cell according to the eighteenth aspect of the present invention includes: a vessel to receive an aqueous solution containing ammonium ions and at least one type of nitrates and nitrites; and an anode and a cathode both in the vessel, the cathode being the nitrate reduction electrode according to the seventeenth aspect.

The water treatment apparatus according to the nineteenth aspect of the present invention includes: a vessel to receive an aqueous solution containing at least one type of nitrates and nitrites; and an anode and a cathode both in the vessel, the cathode being the nitrate reduction electrode according to the seventeenth aspect.

The water treatment apparatus according to the twentieth aspect of the present invention includes: a vessel to receive an aqueous solution containing ammonium ions and at least one type of nitrates and nitrites; a base material which is electrically conductive and disposed in the vessel; an oxidation catalyst supported on the base material; and the nitrate reduction catalyst, the nitrate reduction catalyst which is supported on the base material and not in contact with the oxidation catalyst may be the carbon-based material according to the fifteenth aspect.

Embodiments of the present invention will be more specifically described below.

A nitrate reduction catalyst of the present embodiment contains a carbon-based material containing at least one of graphite, graphene, and amorphous carbon. The nitrate reduction catalyst shows high catalytic activity for nitrate reduction. Therefore, in the presence of this nitrate reduction catalyst, reduction reactions of nitrates and nitrites proceed effectively.

In the past, a carbon-based material such as graphite has been considered to be poor in catalytic activity. However, as a result of vigorous research, the present inventors found that the carbon-based material containing at least one of graphite, graphene, and amorphous carbon showed an effect of promoting the nitrate reduction reaction, and the present inventors successfully prepared the nitrate reduction catalyst of the present embodiment, based on the above facts.

Besides, a noble metal catalyst such as platinum is prone to be poisoned by organic substances such as methanol, and therefore the catalytic activity thereof is prone to decrease. In contrast, the nitrate reduction catalyst of the present embodiment has an advantage of being less likely to be poisoned by organic substances such as methanol.

Note that, the graphene may include at least one of: single-layer graphene which consists of one graphene sheet; and multilayer graphene in which graphene sheets are stacked. The graphene sheet has a structure of sp²-bonded carbon atoms. In graphene, the number of stacked graphene sheets is preferably 10 or less.

Amorphous carbon is, for example, defined as a carbon-based material which has such low crystallinity that an intensity of a (002) peak in a diffraction pattern obtained by X-ray diffraction measurement of the amorphous carbon by use of CuKα radiation is less than ten times as high as an intensity of a (002) peak in a diffraction pattern obtained by X-ray diffraction measurement of ketjenblack EC 300J (product name) available from Lion Corporation by use of CuKα radiation.

An embodiment in a case where the carbon-based material contains graphene will be described.

Regarding the carbon-based material, it is particularly preferable that an intensity ratio of a D-band to a G-band measured using Raman spectroscopy is 1.0 or more. In this case, the catalytic activity of the carbon-based material is remarkably high. This may be because the carbon-based material having a great intensity ratio of the D-band to the G-band has a high edge content and a high defect content. The catalytic activity inherent in the carbon-based material may be improved owing to these edges and defects. That is, edges and defects form a density of states near the Fermi level, and serve as active sites for a reaction such as a nitrate reduction reaction.

The carbon-based material of the present embodiment is preferably prepared by reducing graphene oxide. In this case, graphene oxide contains many defects, and therefore many defects are introduced into graphene obtained by reduction of graphene oxide. The defects form a density of states near the Fermi level and serve as active sites for a reaction such as a nitrate reduction reaction. Therefore, the catalytic activity of the carbon-based material per se is more improved with an increase in the defect content. Thus-obtained graphene has remarkably high edge and defect contents, compared with those obtained by the CVD method, the scotch tape method, and the like. Furthermore, an oxygen atom content of the carbon-based material can be decreased by sufficiently removing oxygen in reducing the graphene oxide. Therefore, obtained can be a carbon-based material which has high electrical conductivity and shows high catalytic activity.

A preferable method of preparing the carbon-based material of the present embodiment will be described more specifically.

Graphene oxide is prepared by known methods. A representative example of the method of preparing graphene oxide may be the modified Hummers' method. In preparation of the graphene oxide, the reaction temperature, the reaction time, and the like are preferably controlled properly so that the carbon-based material has a sufficiently high edge content and many defects.

A preferable mode of the method of preparing graphene oxide will be described below. In the present mode, graphite and concentrated sulfuric acid are mixed to prepare a mixture. As requested, potassium nitrate may be further mixed therein. An amount of the concentrated sulfuric acid preferably falls within a range of 50 mL to 200 mL and more preferably falls within a range of 100 mL to 150 mL, based on 3 g of the graphite. Besides, an amount of the potassium nitrate is preferably 5 g or less, and more preferably falls within a range of 3 g to 4 g, based on 3 g of the graphite.

Potassium permanganate is slowly added to the mixture in a reactor while the reactor is cooled preferably with an ice bath or the like. An addition amount of the potassium permanganate preferably falls within a range of 3 g to 18 g and more preferably falls within a range of 11 g to 15 g, based on 3 g of the graphite. Subsequently, the resultant mixture is stirred so that the reaction proceeds. A reaction temperature at this step preferably falls within a range of 30° C. to 55° C., and more preferably falls within a range of 30° C. to 40° C. Besides, a reaction time at this step preferably falls within a range of 30 min to 90 min.

Subsequently, ion-exchanged water is added into the resultant mixture. An amount of the ion-exchanged water preferably falls within a range of 30 mL to 350 mL and more preferably falls within a range of 170 mL to 260 mL, based on 3 g of the graphite.

Then, the mixture is heated and stirred so that the reaction further proceeds at a reaction temperature for a reaction time. The reaction temperature preferably falls within a range of 80° C. to 100° C. The reaction time is preferably longer than 20 min.

Subsequently, to finish the reaction, the temperature of the mixture is sufficiently lowered by, for example, adding ion-exchanged water to the mixture, and hydrogen peroxide is added to the resulting mixture. An amount of the ion-exchanged water is not particularly limited so long as the temperature of the mixture is sufficiently lowered. In addition, an amount of the hydrogen peroxide is not particularly limited, but 10 mL or more of 30% hydrogen peroxide is preferably used, and 15 mL or more is more preferably used, based on 3 g of the graphite, for example.

Subsequently, the resultant mixture is washed with hydrochloric acid and water, and then ions are removed from the mixture by dialysis. Moreover, ultrasonic is applied to thus-obtained mixture to make graphene oxide separated. Consequently, graphene oxide is obtained.

The carbon-based material including graphene is prepared by reducing this graphene oxide. The reduction is performed by appropriate methods. For example, adopted may be a high-temperature reduction method in which graphene oxide is heated so as to be reduced under reducing atmosphere, inert atmosphere, or reduced-pressure atmosphere. For this heat treatment, heating conditions are appropriately selected so as to decrease an oxygen atom content of the carbon-based material. The heating temperature preferably falls within a range of 850° C. to 1200° C., and more preferably falls within a range of 900° C. to 1000° C. The heating time preferably falls within a range of 30 to 120 seconds, and more preferably falls within a range of 30 to 60 seconds.

An embodiment of the nitrate reduction method will be described. In the present embodiment, at least one type of nitrates and nitrites is reduced in a presence of a carbon-based material containing at least one selected from a group consisting of graphite, graphene, and amorphous carbon. Accordingly, the nitrate reduction reaction can proceed efficiently.

Particularly in the present embodiment, it is preferable that an aqueous solution containing at least one type of nitrates and nitrites is prepared, and then a voltage is applied across the aqueous solution by use of a cathode defined by a nitrate reduction electrode which includes the carbon-based material. The carbon-based material has high electrical conductivity and high catalytic activity, and therefore is suitable for use as a catalyst (nitrate reduction electrode catalyst) to make the nitrate reduction reaction proceed at the electrode by an electrochemical method.

The nitrate reduction reaction can proceed efficiently and electrochemically by, for example, selecting a nitrate reduction electrode including the carbon-based material as a cathode, placing an anode and the cathode in the aqueous solution, and applying a voltage between the anode and the cathode under these conditions. In this case, the anode is not particularly limited, but may be made of noble metal such as platinum, rhodium, and palladium.

To make the nitrate reduction reaction proceed, the pH of the aqueous solution is preferably adjusted to a range of −0.5 to −0.7. Within this range of the pH, the nitrate reduction reaction proceeds more efficiently. The pH of the aqueous solution is adjusted by appropriate techniques. For example, the pH of the aqueous solution is adjusted by adding at least one of an acidic substance and an alkaline substance into the aqueous solution. The acidic substance may be nitric acid. In this case, the pH of the aqueous solution can be adjusted by use of nitric acid which is also involved in the reaction. The acidic substance may be acid other than nitric acid, for example, sulfuric acid. To adjust the pH, the acidic substance or the alkaline substance may be added into the aqueous solution at an appropriate timing. For example, prior to application of the voltage across the aqueous solution, the acidic substance or the alkaline substance may be added. The acidic substance or the alkaline substance may be added in the aqueous solution in a state of application of the voltage across the aqueous solution.

When the aqueous solution contains nitrates, in order to make the nitrate reduction reaction proceed in the aqueous solution, nitrites are preferably added into the aqueous solution. In this case, the nitrite serves as a catalyst to make the reduction reaction of the nitrates proceed. Therefore, the nitrate reduction reaction proceeds more efficiently. The method of adding nitrites into the aqueous solution may include a step of adding nitrous acid into the aqueous solution and/or a step of adding an appropriate nitrite salt into the aqueous solution. The nitrites may be added into the aqueous solution at an appropriate timing. For example, prior to application of the voltage across the aqueous solution, the nitrites may be added. The nitrites may be added into the aqueous solution in a state of application of the voltage across the aqueous solution.

The electrochemical nitrate reduction method by use of the carbon-based material and a device therefor will be more specifically described below.

The carbon-based material has high electrical conductivity and high catalytic activity, and therefore is suitable for use as a catalyst (electrode catalyst) to make the nitrate reduction reaction proceed at an electrode by an electrochemical method. Furthermore, the carbon-based material is suitable for use as a catalyst (nitrate reduction electrode catalyst) to make the nitrate reduction reaction proceed at an electrode.

The electrode including the carbon-based material is suitable for use as an electrode (nitrate reduction electrode) for making the nitrate reduction reaction proceed electrochemically. The nitrate reduction electrode is prepared by, for example, dispersing the carbon-based material into ethanol, dropping thus-obtained dispersion and a Nafion binder on glassy carbon, and drying them.

Such a nitrate reduction electrode can efficiently promote the nitrate reduction reaction in which nitrates and nitrites are reduced to produce nitrogen gas. Note that, the nitrate reduction reaction in which the nitrite is a starting material is expressed as follows, for example.

2NO₂⁻+8H⁺+6e⁻→N₂+4H₂O

Such a nitrate reduction electrode can compose an electrochemical device for efficiently removing nitrogen compounds from water by evolving nitrogen gas by treatment of the water containing the nitrogen compounds.

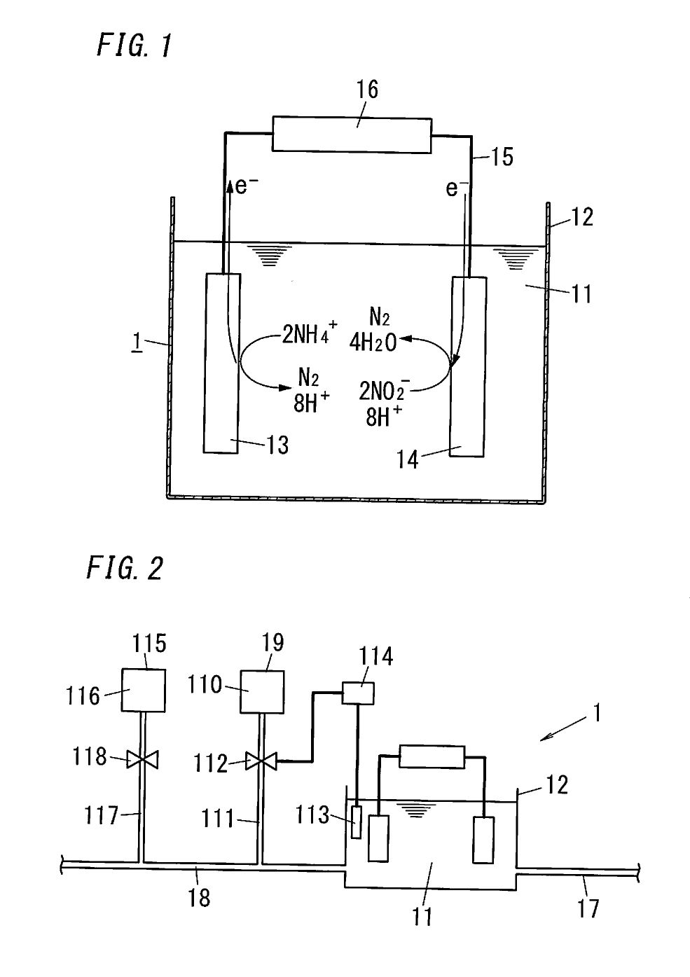

Such an electrochemical device may be a water treatment apparatus for removing nitrogen compounds from water such as wastewater. FIG. 1 shows a configuration example of the water treatment apparatus.

This water treatment apparatus 1 includes: a vessel 12 to receive an aqueous solution (hereinafter, referred to as liquid 11 to be treated) to be subjected to treatment; and an anode 13 and a cathode 14 both in the vessel 12. The cathode 14 is the nitrate reduction electrode of the present embodiment. The anode 13 is made of noble metal such as platinum, rhodium, and palladium.

The anode 13 and the cathode 14 are connected via external wirings 15. The external wirings 15 are connected to a voltage application unit 16 and the like.

To the vessel 12 of the water treatment apparatus composed as described above, the liquid 11 to be treated which contains at least one type of nitrates and nitrites is supplied. Note that, for a treatment of an aqueous solution containing ammoniacal nitrogen such as wastewater, first, parts of ammoniacal nitrogen in the aqueous solution may be nitrified into nitrates or nitrites by bacteria to prepare the liquid 11 to be treated which contains ammonium ions and at least one type of nitrates and nitrites, and thereafter thus-obtained liquid 11 to be treated should be supplied to the vessel of the water treatment apparatus.

Accordingly, the following nitrate reduction reaction proceeds at the cathode 14, for example.

2NO₂⁻+8H⁺+6e⁻→N₂+4H₂O

Besides, the following oxidation reaction proceeds at the anode 13, for example.

2H₂O→O₂+4H⁺+4e⁻

As a result of the treatment, nitrogen compounds are removed from the liquid 11. The water treatment apparatus 1 composed as described above includes the nitrate reduction electrode of the present embodiment as the cathode 14, and therefore can make the nitrate reduction reaction proceed efficiently and has an improved efficiency in the treatment.

The water treatment apparatus 1 may further include at least one of a pH adjuster for adjusting the pH of the liquid 11 to be treated to a range of −0.5 to −0.7 and a nitrite supplier for supplying nitrites to the liquid 11 to be treated. In this case, the nitrate reduction reaction proceeds more efficiently using the water treatment apparatus 1.

FIG. 2 shows a schematic view of a configuration example of a water treatment apparatus 1 which includes the pH adjuster and the nitrite supplier. The water treatment apparatus 1 is further different from that of the embodiment shown in FIG. 1 in including an inlet pipe 18 and an outlet pipe 17. The liquid 11 to be treated passes through the inlet pipe 18 and is supplied to the vessel 12. The outlet pipe 17 allows a passage of a liquid that is discharged from the vessel 12 after subjected to the treatment. The water treatment apparatus 1 further includes, as the pH adjuster, an acidic substance supply unit 19 for supplying an acidic substance to the inlet pipe 18. Besides, the water treatment apparatus 1 includes, as the nitrite supplier, a nitrite supply unit 115 for supplying nitrites to the inlet pipe 18.

In the embodiment shown in FIG. 2, the acidic substance supply unit 19 includes: a tank 110 to store an aqueous solution of an acidic substance such as aqueous solution of sulfuric acid and an aqueous solution of nitric acid; an acid supply pipe 111 to connect the tank 110 with the inlet pipe 18; and an on-off valve 112 to open and close the acid supply pipe 111. In this case, when the on-off valve 112 is opened, the acidic substance is supplied to the inlet pipe 18 and then added into the liquid 11 to be treated. Accordingly, the pH of the liquid 11 to be treated is adjusted. The acidic substance supply unit 19 may further include: a pH meter 113 to measure the pH of the liquid 11 in the vessel 12; and a control unit 114 to control on-off operation of the on-off valve 112 based on the measurement result of the pH meter 113. For example, the control unit 114 is configured to; when the pH of the liquid 11 is greater than a predetermined value, open the on-off valve 112; and, when the pH of the liquid 11 is the predetermined value or less, close the on-off valve 112. In this case, the pH of the liquid 11 is automatically adjusted.

Besides, in the embodiment shown in FIG. 2, the nitrite supply unit 115 includes: a tank 116 to store an aqueous solution containing nitrites such as an aqueous solution of nitrous acid and an aqueous solution of nitrite salt; a nitrite supply pipe 117 to connect the tank 116 with the inlet pipe 18; and an on-off valve 118 to open and close the nitrite supply pipe 117. In this case, the on-off valve 118 is opened to supply nitrites to the inlet pipe 18, and then the nitrites are added into the liquid 11 to be treated.

Note that configurations of the acidic substance supply unit 19 and the nitrite supply unit 115 are not limited to the above examples. For example, the acidic substance supply unit 19 may be configured to supply an acidic substance directly to the vessel 12. Besides, the nitrite supply unit 115 may be configured to supply nitrites directly to the vessel 12.

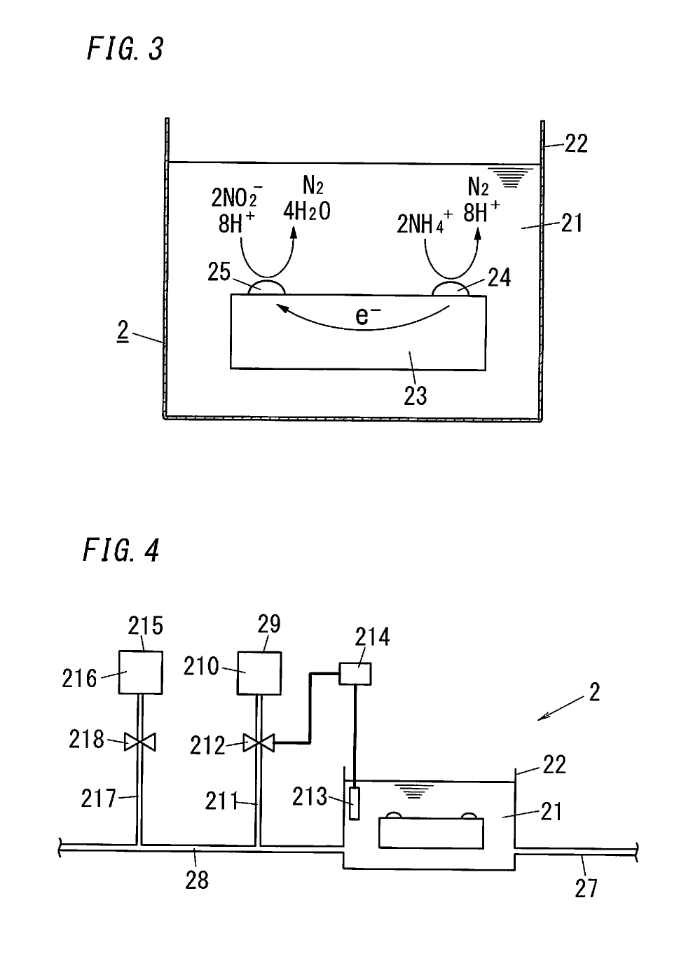

The carbon-based material of the present embodiment can compose a local cell-type water treatment apparatus 2 as shown in FIG. 3. The water treatment apparatus 2 includes: a vessel 22 to receive a liquid 21 to be treated; a base material 23 which is electrically conductive and disposed in the vessel 22; an oxidation catalyst 24 supported on the base material; and a nitrate reduction catalyst 25 which is supported on the base material 23 and not in contact with the oxidation catalyst 24. The nitrate reduction catalyst 25 includes the carbon-based material of the present embodiment. The base material 23 having electrical conductivity may be made of, for example, a carbon plate, carbon paper, a carbon disk, an electrically conductive polymer, a semiconductor, metal, or the like, but may not. The oxidation catalyst 24 may be made of platinum, but is not particularly limited.

To the vessel 22 of the water treatment apparatus 2 composed as described above, the liquid 21 to be treated which contains at least one type of nitrates and nitrites is supplied. Note that, for a treatment of an aqueous solution containing ammoniacal nitrogen such as wastewater, first, parts of ammoniacal nitrogen in the aqueous solution may be nitrified into nitrates or nitrites by bacteria to prepare the liquid 21 to be treated which contains ammonium ions and at least one type of nitrates and nitrites. Subsequently, thus-obtained liquid 21 to be treated should be supplied to the vessel 22 of the water treatment apparatus.

Accordingly, at the oxidation catalyst 24 on the base material 23, the following oxidation reaction proceeds, for example.

2NH₄⁺→N₂+8H⁺+6e⁻

Electrons emitted in this reaction migrate to the nitrate reduction catalyst 25 via the base material 23. In contrast, at the nitrate reduction catalyst 25, the following nitrate reduction reaction proceeds, for example.

2NO₂⁻+8H⁺+6e⁻→N₂+4H₂O

As a result of the treatment, nitrogen compounds are removed from the liquid 21. The water treatment apparatus 2 composed as described above includes the nitrate reduction catalyst 25 including the carbon-based material of the present embodiment, and therefore can make the nitrate reduction reaction proceed efficiently and has an improved efficiency in the treatment.

Similarly to the water treatment apparatus 1 shown in FIG. 2, the water treatment apparatus 2 may further include at least one of the pH adjuster and the nitrite supplier. The pH adjuster adjusts the pH of the liquid to be treated by the water treatment apparatus 2 to a range of −0.5 to −0.7. The nitrite supplier supplies nitrites to the liquid to be treated by the water treatment apparatus 2. In this case, the nitrate reduction reaction caused by the water treatment apparatus 2 proceeds more efficiently. The water treatment apparatus 2 may only include the nitrite supplier out of the pH adjuster and the nitrite supplier.

FIG. 4 shows a schematic view of a configuration example of a water treatment apparatus 2 which includes the pH adjuster and the nitrite supplier. The water treatment apparatus 2 is further different from that of the embodiment shown in FIG. 3 in including an inlet pipe 28 and an outlet pipe 27. The liquid 21 to be treated passes through the inlet pipe 28 and is supplied to the vessel 22. The outlet pipe 27 allows a passage of a liquid that is discharged from the vessel 22 after being subjected to the treatment. The water treatment apparatus 2 further includes, as the pH adjuster, an acidic substance supply unit 29 for supplying an acidic substance to the inlet pipe 28. Besides, the water treatment apparatus 2 includes, as the nitrite supplier, a nitrite supply unit 215 for supplying nitrites to the inlet pipe 28.

In the embodiment shown in FIG. 4, the acidic substance supply unit 29 includes: a tank 210 to store an aqueous solution of an acidic substance such as aqueous solution of sulfuric acid and an aqueous solution of nitric acid; an acid supply pipe 211 to connect the tank 210 with the inlet pipe 28; and an on-off valve 212 to open and close the acid supply pipe 211. In this case, when the on-off valve 212 is opened, the acidic substance is supplied to the inlet pipe 28 and then added into the liquid 21 to be treated. Accordingly, the pH of the liquid 21 to be treated is adjusted. The acidic substance supply unit 29 may further include: a pH meter 213 to measure the pH of the liquid 21 in the vessel 22; and a control unit 214 to control on-off operation of the on-off valve 212 based on the measurement result of the pH meter 213. For example, the control unit 214 is configured to; when the pH of the liquid 21 is greater than a predetermined value, open the on-off valve 212; and, when the pH of the liquid 21 is the predetermined value or less, close the on-off valve 212. In this case, the pH of the liquid 21 is automatically adjusted.

Besides, in the embodiment shown in FIG. 4, the nitrite supply unit 215 includes: a tank 216 to store an aqueous solution containing nitrites such as an aqueous solution of nitrous acid and an aqueous solution of nitrite salt; a nitrite supply pipe 217 to connect the tank 216 with the inlet pipe 28; and an on-off valve 218 to open and close the nitrite supply pipe 217. In this case, the on-off valve 218 is opened to supply nitrites to the inlet pipe 28, and then the nitrites are added into the liquid 21 to be treated.

Note that configurations of the acidic substance supply unit 29 and the nitrite supply unit 215 are not limited to the above examples. For example, the acidic substance supply unit 29 may be configured to supply an acidic substance directly to the vessel 22. Besides, the nitrite supply unit 215 may be configured to supply nitrites directly to the vessel 22.

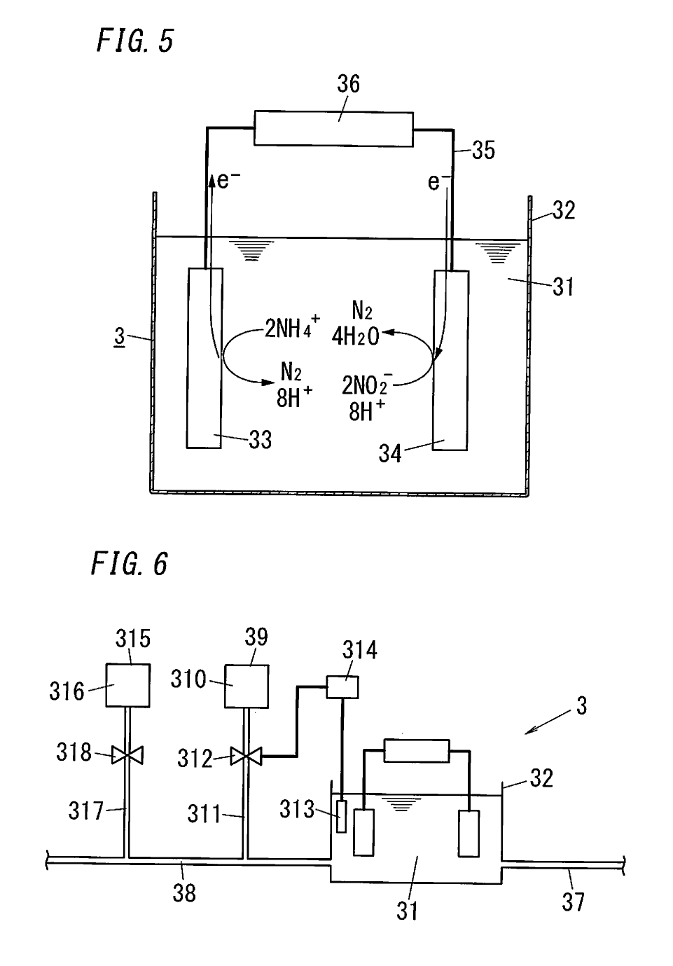

The electrochemical device including the nitrate reduction electrode of the present embodiment may be a fuel cell. FIG. 5 shows a configuration example of the fuel cell.

This fuel cell 3 includes: a vessel 32 to receive an aqueous solution (hereinafter, referred to as fuel solution 31) which contains an oxidizing agent and a reducing agent; and an anode 33 and a cathode 34 both in the vessel 32. The cathode 34 is the nitrate reduction electrode of the present embodiment. The anode 33 is made of noble metal such as platinum, rhodium, and palladium.

The anode 33 and the cathode 34 are connected to an external resistor 36 via external wirings 35.

To the vessel 32 of the fuel cell 3 composed as described above, the fuel solution 31 which contains ammonium ions as a reducing agent and at least one type of nitrates and nitrites as an oxidizing agent is supplied. Note that, for a treatment of an aqueous solution containing ammoniacal nitrogen such as wastewater, first, parts of ammoniacal nitrogen in the aqueous solution may be nitrified into nitrates or nitrites by bacteria to prepare the fuel solution 31 which contains ammonium ions and at least one type of nitrates and nitrites. Subsequently, thus-obtained fuel solution 31 should be supplied to the vessel 32 of the fuel cell.

Accordingly, the following nitrate reduction reaction proceeds at the cathode 34, for example.

2NO₂⁻+8H⁺+6e⁻→N₂+4H₂O

Besides, the following oxidation reaction proceeds at the anode 33, for example.

2NH₄⁺→N₂+8H⁺+6e⁻

By these electrochemical reactions, an electromotive force is generated. The fuel cell 3 composed as described above includes the nitrate reduction electrode of the present embodiment as the cathode 34, and therefore nitrate removal is performed without external energy.

Similarly to the water treatment apparatuses 1 and 2 shown in FIGS. 2 and 4 respectively, the fuel cell 3 may further include at least one of the pH adjuster and the nitrite supplier. The pH adjuster adjusts the pH of the solution of the fuel cell 3 to a range of −0.5 to −0.7. The nitrite supplier supplies nitrites to the solution of the fuel cell 3. In this case, the nitrate reduction reaction caused by the fuel cell 3 proceeds more efficiently. The fuel cell 3 may include only the nitrite supplier out of the pH adjuster and the nitrite supplier.

FIG. 6 shows a schematic view of a configuration example of a fuel cell 3 which includes the pH adjuster and the nitrite supplier. The fuel cell 3 is further different from that of the embodiment shown in FIG. 5 in including an inlet pipe 38 and an outlet pipe 37. The fuel solution 31 passes through the inlet pipe 38 and is supplied to the vessel 32. The outlet pipe 37 allows a passage of a liquid discharged from the vessel 32 after being subjected to the treatment. The fuel cell 3 further includes, as the pH adjuster, an acidic substance supply unit 39 for supplying an acidic substance to the inlet pipe 38. Besides, the fuel cell 3 includes, as the nitrite supplier, a nitrite supply unit 315 for supplying nitrites to the inlet pipe 38.

In the embodiment shown in FIG. 6, the acidic substance supply unit 39 includes: a tank 310 to store an aqueous solution of an acidic substance such as aqueous solution of sulfuric acid and an aqueous solution of nitric acid; an acid supply pipe 311 to connect the tank 310 with the inlet pipe 38; and an on-off valve 312 to open and close the acid supply pipe 311. In this case, when the on-off valve 312 is opened, the acidic substance is supplied to the inlet pipe 38 and then added into the fuel solution 31. Accordingly, the pH of the fuel solution 31 is adjusted. The acidic substance supply unit 39 may further include: a pH meter 313 to measure the pH of the fuel solution 31 in the vessel 32; and a control unit 314 to control on-off operation of the on-off valve 312 based on the measurement result of the pH meter 313. For example, the control unit 314 is configured to; when the pH of the fuel solution 31 is greater than a predetermined value, open the on-off valve 312; and, when the pH of the fuel solution 31 is the predetermined value or less, close the on-off valve 312. In this case, the pH of the fuel solution 31 is automatically adjusted.

Besides, in the embodiment shown in FIG. 6, the nitrite supply unit 315 includes: a tank 316 to store an aqueous solution containing nitrites such as an aqueous solution of nitrous acid and an aqueous solution of nitrite salt; a nitrite supply pipe 317 to connect the tank 316 with the inlet pipe 38; and an on-off valve 318 to open and close the nitrite supply pipe 317. In this case, the on-off valve 318 is opened to supply nitrites to the inlet pipe 38, and then the nitrites are added into the fuel solution 31.

Note that configurations of the acidic substance supply unit 39 and the nitrite supply unit 315 are not limited to the above example. For example, the acidic substance supply unit 39 may be configured to supply an acidic substance directly to the vessel 32. Besides, the nitrite supply unit 315 may be configured to supply nitrites directly to the vessel 32.

### EXAMPLES

### Preparation of Carbon-Based Material

In a reactor, 3 g of graphite (Wako 40 mm), 138 mL of concentrated sulfuric acid, and 3.47 g of potassium nitrate were mixed to prepare a mixture liquid. Potassium permanganate was further added slowly thereto, with the reactor being in an ice bath. Subsequently, thus-obtained mixture liquid was stirred at 40° C. for 30 min, and then 240 mL of ion-exchanged water was added thereto, followed by stirring and heating at 90° C. for 1 hour. Thereafter, into the reactor, 600 mL of ion-exchanged water and 18 mL of 30% hydrogen peroxide solution were added to finish the reaction. Then, the resultant mixture liquid was washed with hydrochloric acid and water, followed by removing ions therefrom by dialysis. Furthermore, ultrasonic was applied to the resulting mixture liquid to make graphene oxide separated.

Thus obtained sample was placed in an end of a quartz tube, and an atmosphere in the quartz tube was replaced by argon. This quartz tube was inserted in an oven at 900° C., placed for 45 sec, and then taken out. Thereafter, the sample was cooled by allowing argon gas to pass through the quartz tube. Consequently, a carbon-based material was obtained.

### Nitrate Reduction Activity Evaluation

First, 5 mg of a carbon-based material, 175 mL of ethanol, and 47.5 mL of 5% Nafion dispersion were mixed to prepare a mixture, and the mixture was subjected to ultrasonic dispersion.

Next, 2.5 mL of the resultant mixture was dropped onto a GC (glassy carbon) electrode having an area of 0.07 cm². Accordingly, the carbon-based material was attached to the electrode at an attached amount of about 800 mg/cm². Using this electrode as a working electrode, cyclic voltammetry was performed at 40° C. in an aqueous solution of 5 M HNO₃, which was an electrolyte liquid (Example 1-1). Besides, using a GC electrode without the carbon-based material as a working electrode, cyclic voltammetry was performed under the same conditions (Example 1-2).

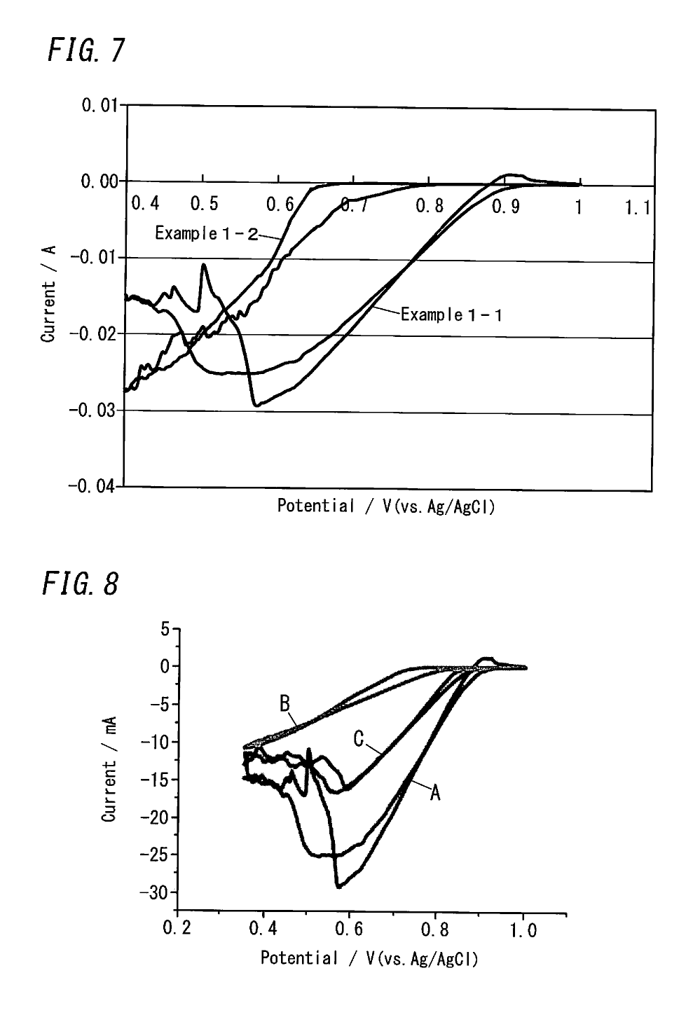

FIG. 7 shows thus-obtained voltammograms. As shown in these results, using the electrode which includes the carbon-based material provides smaller overpotential by 0.2 to 0.3 V than using the GC electrode without the carbon-based material. This value is smaller than an overpotential for the nitrate reduction using platinum (see, 5M HNO₃+0.5M H₂SO₄, M. T. de Groot, M. T. M. Koper, Journal of Electroanalytical Chemistry, 562 (2004) 81-94).

### Example 2

### Example 2-1

A carbon-based material (graphene) was obtained in the same manner as that in Example 1. Subsequently, an electrode was prepared by attaching the carbon-based material to a GC electrode having an area of 0.07 cm² at an attached amount of about 100 mg/cm² in the same manner as that in Example 1.

### Example 2-2

Graphite was prepared as a carbon-based material. Subsequently, an electrode was prepared by attaching the carbon-based material to a GC electrode having an area of 0.07 cm² at an attached amount of about 100 mg/cm² in the same manner as that in Example 1.

### Example 2-3

Graphite was prepared as a carbon-based material. Subsequently, an electrode was prepared by attaching the carbon-based material to a GC electrode having an area of 0.07 cm² at an attached amount of about 800 mg/cm² in the same manner as that in Example 1.

### Nitrate Reduction Activity Evaluation

For each of working electrodes defined by the electrodes obtained in Examples 2-1, 2-2, and 2-3, cyclic voltammetry was performed at room temperature in an aqueous solution of 0.5 M HNO₃, which was an electrolyte liquid.

FIG. 8 shows thus-obtained voltammograms. In this regard, “A”, “B” and “C” in FIG. 8 indicate the results regarding Examples 2-1, 2-2, and 2-3, respectively.

As shown in these results, the electrode including graphene obtained in Example 2-1 showed nitrate reduction activity as high as that obtained in Example 1. Besides, the electrode including graphite obtained in Example 2-2 showed nitrate reduction activity. However, this nitrate reduction activity was smaller than that obtained in Example 1. The electrode including more amount of graphite obtained in Example 2-3 than that in Example 2-2 showed higher nitrate reduction activity.

### Example 3

The following Examples were made to confirm pH dependency of the nitrate reduction reaction in the case of using the carbon-based material.

### Example 3-1

A carbon-based material (graphene) was obtained in the same manner as that in Example 1. Subsequently, an electrode was prepared by attaching the carbon-based material to a GC electrode having an area of 0.07 cm² at an attached amount of about 100 mg/cm² in the same manner as that in Example 1.

Using this electrode as a working electrode, cyclic voltammetry was performed at room temperature in an aqueous solution of 5 M HNO₃ (pH: −0.7), which was an electrolyte liquid.

In addition, for comparison, cyclic voltammetry using a platinum electrode as a working electrode was performed under the same conditions (Comparative Example 3-1).

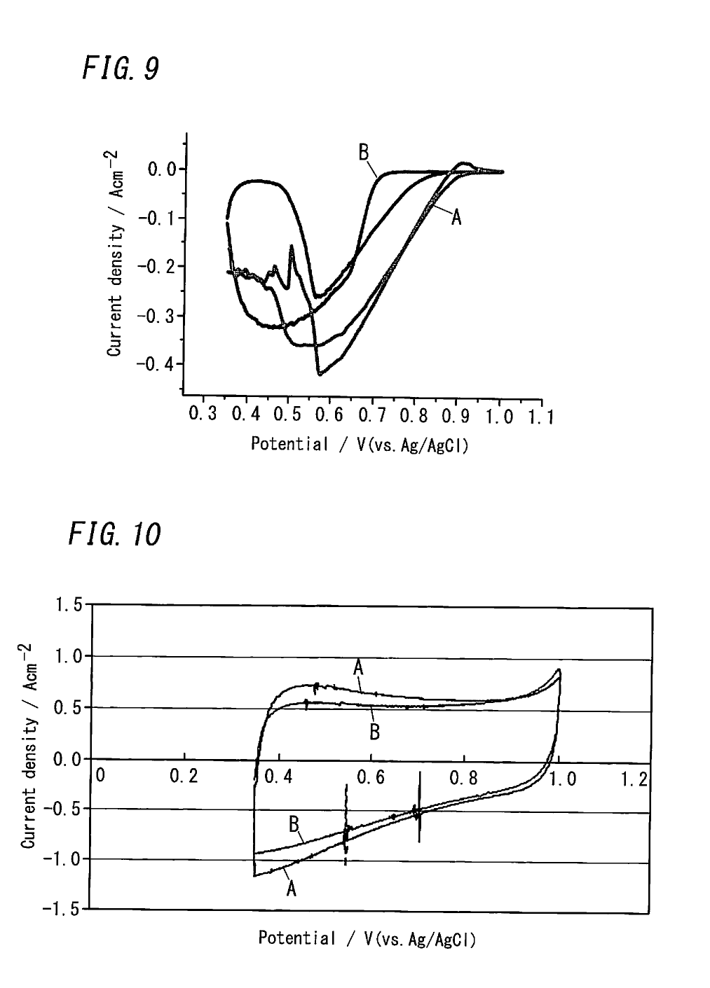

FIG. 9 shows thus-obtained voltammograms. As shown in these results, the electrode including the carbon-based material provides high nitrate reduction activity as well as a smaller overpotential than the platinum electrode.

### Example 3-2

Cyclic voltammetry was performed in an aqueous solution of 0.1 M HNO₃ (pH: 1) at room temperature using an electrode having the same configuration as that in Example 3-1 as a working electrode. In FIG. 10, “A” indicates this result. In addition, cyclic voltammetry was performed in pure water instead of the electrolyte liquid using this electrode as a working electrode at room temperature. In FIG. 10, “B” indicates this result. These results confirm that the nitrate reduction activity decreases with an increase in the pH of the electrolyte liquid even in the case of using the electrode which includes graphene.

### Example 3-3

Cyclic voltammetry was performed in an aqueous solution of 0.1 M HNO₃ and 5 M H₂SO₄ (pH: −0.7) using an electrode having the same configuration as that in Example 3-1 as a working electrode at room temperature.

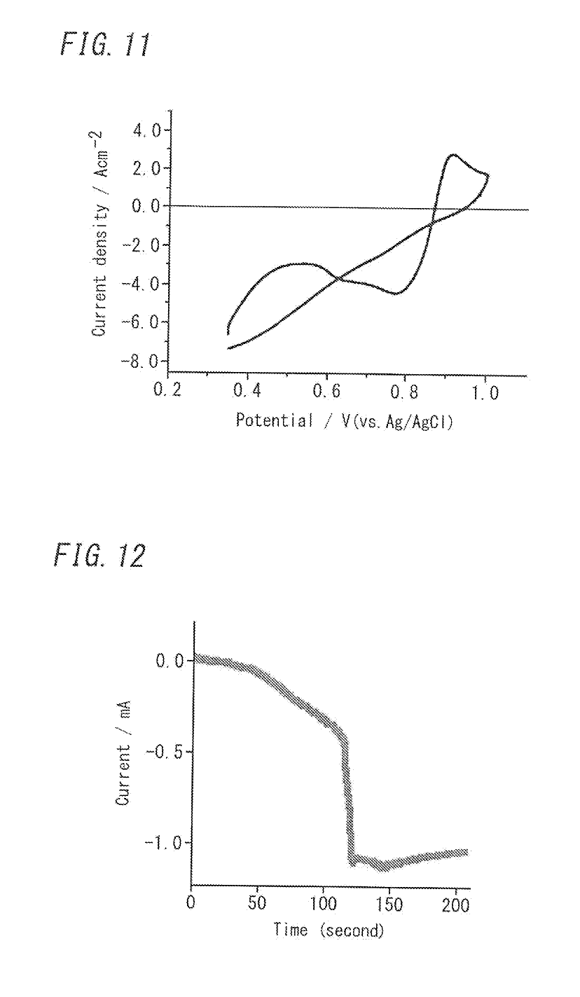

FIG. 11 shows thus-obtained voltammograms. This result confirms high nitrate reduction activity. Therefore, it is confirmed that the nitrate reduction activity is improved with a decrease in the pH of the electrolyte liquid by addition of H₂SO₄ even when the concentration of the HNO₃ was the same as that in Example 3-2.

### Example 4

The following Examples were made to confirm nitrite dependency of the nitrate reduction reaction in the case of using the carbon-based material.

### Example 4-1

A carbon-based material (graphene) was obtained in the same manner as that in Example 1. Subsequently, an electrode was prepared by attaching the carbon-based material to a GC electrode having an area of 0.07 cm² at an attached amount of about 100 mg/cm² in the same manner as that in Example 1.

The thus-obtained electrode, a platinum electrode, and an aqueous solution of 5 M HNO₃ were prepared as a cathode, an anode, and an electrolyte liquid respectively to compose an electrode system. A change in a current between the anode and the cathode was observed while a constant voltage was applied between the cathode and anode so that the potential of the cathode was 0.6 V (vs. Ag/AgCl) in the electrode system. FIG. 12 shows this result.

This result confirmed that the current gradually increased for a while from the time of starting application of the voltage, and then rapidly increased from a certain time. This may be because a reduction reaction of nitrates gradually proceeds at first and the nitrites as a reaction intermediate are accumulated in the electrolyte liquid, and then the accumulated nitrites show catalytic function and cause a rapid rise in a nitrate reduction reaction rate at the certain time.

### Example 4-2

A carbon-based material (graphene) was obtained in the same manner as that in Example 1. Subsequently, an electrode was prepared by attaching the carbon-based material to a GC electrode having an area of 0.07 cm² at an attached amount of about 100 mg/cm² in the same manner as that in Example 1.

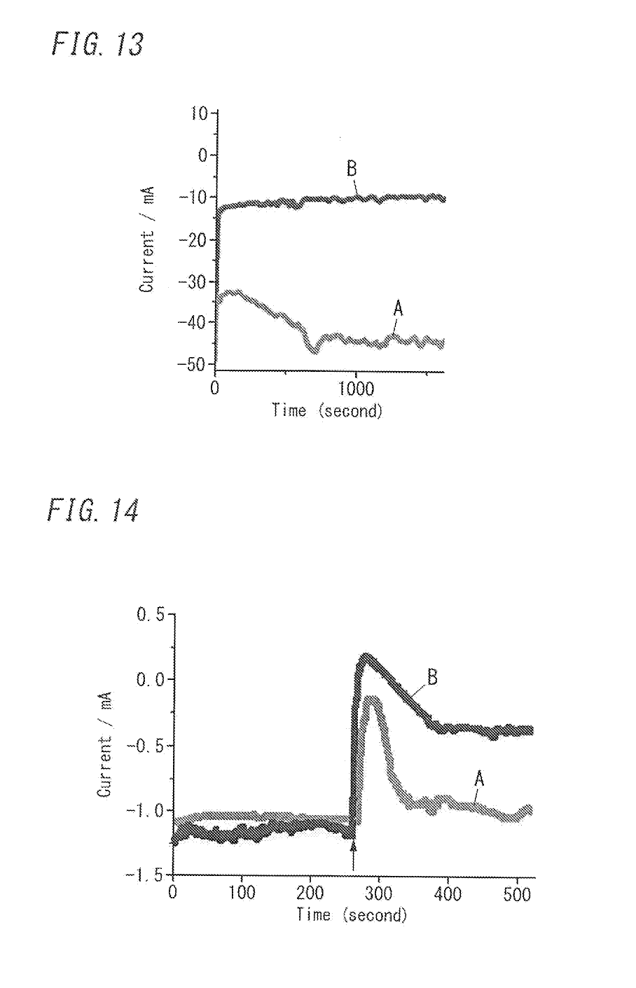

The electrode, a platinum electrode, and an aqueous solution which contains 5 M H₂SO₄, 10 mM HNO₃, and 1 mM HNO₂, were prepared as a cathode, an anode, and an electrolyte liquid respectively to compose an electrode system. A change in a current between the anode and the cathode was observed while a constant voltage was applied between the cathode and anode so that the potential of the cathode was 0.6 V (vs. Ag/AgCl) in the electrode system. In FIG. 13, “A” indicates the result.

The result indicated by “A” confirmed that a great current flowed between the cathode and the anode immediately after the voltage application. This may because nitrites were present in the electrolyte liquid at the time of starting application of the voltage, and therefore the catalytic function of the nitrites caused a rapid increase in the nitrate reduction reaction rate immediately after the voltage application.

Besides, using an aqueous solution of 5 M H₂SO₄ and 1 mM HNO₂ but without HNO₃, a change in a current between the anode and the cathode was observed while a constant voltage was applied between the cathode and anode in the same manner. In FIG. 13, “B” indicates this result.

The result indicated by “B” confirmed that the current, which was smaller than that indicated by “A”, flowed between the cathode and the anode immediately after the voltage application. This current is considered to be a reduction current occurring at reduction of the nitrites. In this regard, it is considered that a difference between the current values of the results indicated by “A” and “B” corresponds to a reduction current occurring at reduction of the nitrates.

### Example 5

The following Examples were made to confirm poison resistance of the carbon-based material for make the nitrate reduction reaction proceed by use of the carbon-based material.

A carbon-based material (graphene) was obtained in the same manner as that in Example 1. Subsequently, an electrode was prepared in the same manner as that in Example 1 by attaching the carbon-based material to a GC electrode having an area of 0.07 cm² at an attached amount of about 100 mg/cm².

The thus-obtained electrode, a platinum electrode, and an aqueous solution of 5 M HNO₃ were prepared as a cathode, an anode, and an electrolyte liquid respectively to compose an electrode system. In this electrode system, a constant voltage was applied between the cathode and anode so that the potential of the cathode was 0.6 V (vs. Ag/AgCl). The electrode system was left in this state for a while, and then methanol was added into the electrolyte liquid to have a concentration of 100 mM in the electrolyte liquid. In FIG. 14, “A” indicates the result of the observation of a change in a current flowing between the anode and the cathode in this case. Note that, an arrow in FIG. 14 shows a time for addition of methanol into the electrolyte liquid.

As shown in the result indicated by “A”, the current rapidly decreased immediately after the addition of methanol into the electrolyte liquid, and then promptly returned. As a result, the current became slightly smaller than but substantially same as that before the addition of methanol. Accordingly, it can be determined that the carbon-based material is less likely to be poisoned by methanol.

For comparison, “B” in FIG. 14 indicates the result of the case where the cathode is a platinum electrode, alternatively. As shown in the result indicated by “B”, the current rapidly decreased immediately after the addition of methanol into the electrolyte liquid, and thereafter increased a little. However, the current remained greatly smaller than that before the addition of methanol.

### INDUSTRIAL APPLICABILITY

Nitrate reduction methods and nitrate reduction catalysts in accordance with the present invention can be applied to, for example, water treatment, power generation, and the like. However, the applications thereof are not particularly limited.

Water treatment apparatuses in accordance with the present invention can be used for efficiently performing water treatment.

Fuel cells in accordance with the present invention can be used for efficiently performing fuel cell power generation using ammonium ions and at least one type of nitrates and nitrites.

1. A nitrate reduction method of reducing at least one type of nitrates and nitrites in a presence of a carbon-based material containing at least one selected from a group consisting of graphite, graphene, and amorphous carbon.

2. The nitrate reduction method according to claim 1, comprising steps of:
preparing an aqueous solution containing at least one type of the nitrates and the nitrites; and
applying a voltage across the aqueous solution by use of a cathode defined by a nitrate reduction electrode including the carbon-based material.

3. The nitrate reduction method according to claim 1, further comprising a step of adjusting a pH of the aqueous solution to a range of −0.5 to −0.7.

4. The nitrate reduction method according to of claim 1, wherein:
the aqueous solution contains the nitrates; and
the nitrate reduction method further comprises a step of adding the nitrites to the aqueous solution.

5. A nitrate reduction catalyst comprising
a carbon-based material containing at least one selected from a group consisting of graphite, graphene, and amorphous carbon.

6. A nitrate reduction electrode comprising
the nitrate reduction catalyst according to claim 5.

7. The nitrate reduction electrode according to claim 6, wherein
an onset potential for nitrate reduction is 0.8 V vs. Ag/AgCl.

8. A water treatment apparatus comprising:
a vessel to receive an aqueous solution containing at least one type of nitrates and nitrites; and
an anode and a cathode both in the vessel,
the cathode being the nitrate reduction electrode according to claim 6.

9. A water treatment apparatus comprising:
a vessel to receive an aqueous solution containing ammonium ions and at least one type of nitrates and nitrites;
a base material which is electrically conductive and disposed in the vessel;
an oxidation catalyst supported on the base material; and
the nitrate reduction catalyst according to claim 5,
the nitrate reduction catalyst being supported on the base material and not in contact with the oxidation catalyst.

10. The water treatment apparatus according to claim 8, further comprising
a nitrite supplier for supplying the nitrites to the aqueous solution.

11. A fuel cell comprising:
a vessel to receive an aqueous solution containing ammonium ions and at least one type of nitrates and nitrites; and
an anode and a cathode both in the vessel,
the cathode being the nitrate reduction electrode according to claim 6.

12. The fuel cell according to claim 11, further comprising
a nitrite supplier for supplying the nitrites to the aqueous solution.

13. The nitrate reduction method according to claim 2, further comprising a step of adjusting a pH of the aqueous solution to a range of −0.5 to −0.7.

14. The nitrate reduction method according to of claim 2, wherein:
the aqueous solution contains the nitrates; and
the nitrate reduction method further comprises a step of adding the nitrites to the aqueous solution.

15. The nitrate reduction method according to of claim 3, wherein:
the aqueous solution contains the nitrates; and
the nitrate reduction method further comprises a step of adding the nitrites to the aqueous solution.

16. A water treatment apparatus comprising:
a vessel to receive an aqueous solution containing at least one type of nitrates and nitrites; and
an anode and a cathode both in the vessel,
the cathode being the nitrate reduction electrode according to claim 7.

17. The water treatment apparatus according to claim 9, further comprising
a nitrite supplier for supplying the nitrites to the aqueous solution.

18. A fuel cell comprising:
a vessel to receive an aqueous solution containing ammonium ions and at least one type of nitrates and nitrites; and
an anode and a cathode both in the vessel,
the cathode being the nitrate reduction electrode according to claim 7.
